(19) United States
(12) Patent Application Publication
(10) Pub. No.: US 2009/0107370 A1
(43) Pub. Date: Apr. 30, 2009

(54) PLANTING DEVICES, STRUCTURES, AND METHODS

(76) Inventor: L. David Ostlie, Corcoran, MN (US)

Correspondence Address: BROOKS, CAMERON & HUEBSCH , PLLC, 1221 NICOLLET AVENUE , SUITE 500, MINNEAPOLIS, MN, 55403, US

(21) Appl. No.: 12/348,680

(22) Filed: Jan. 5, 2009

Related U.S. Application Data
(63) Continuation-in-part of application No. 11/489,897, filed on Jul. 20, 2006, now Pat. No. 7,472,658.

(51) Int. Cl. A01C 11/00

(52) U.S. Cl. 111/100

(57) ABSTRACT

The present disclosure includes various method, structure, and device embodiments for planting of tree slips, seedlings, and other immature plant elements in the ground. One embodiment includes an encasement insertion structure for planting that includes an immature plant element having a length and a circumference and an encasing material formed to surround at least a portion of the immature plant element around the circumference for facilitating insertion of the immature plant element through a ground surface.

### PRIORITY INFORMATION

This application is a Continuation-In-Part of U.S. patent application Ser. No. 11/489,897 filed Jul. 20, 2006, the specification of which is incorporated by reference herein.

### TECHNICAL FIELD

The present disclosure relates generally to planting associated with the fields of agriculture and forestry and, more particularly, to planting of immature plant elements.

### BACKGROUND

Trees can be harvested and used for building material and/or fuel, and can be processed for paper and/or cardboard, among various other wood based products, or other such uses for the harvested trees. It can be desirable or required to plant new trees to replace harvested trees to replenish and maintain forests.

Some trees can be reproduced from slips (e.g., cuttings) taken from existing trees. These slips are often available from nurseries in the form of sticks having a plurality of bud sites thereon. The sticks can come in various lengths and diameters depending upon the type of tree and cultural practices in the local area.

Manually planting the slips by spading, pre-forming holes, or driving them into the ground by hand at desired locations can be slow, highly labor-intensive, and generally costly. The slips can require careful planting placement at predetermined intervals and at a proper predetermined depth.

Mechanized planting has been attempted, but the early prototype tree planting machines had circular shaped stick drivers with a tangentially mounted hammer head that struck the slips in an essentially arcuate motion to drive them into the ground as the planter moved. This tended to damage the slips and often left the planted slip leaning at an undesirable angle with respect to vertical, furthermore, the ground speed of such tree planting machines had to be matched closely to the rotational speed of the driver, thus limiting the speed of planting.

One mechanized planting device plants trees vertically by employing brakes and a pivoting mechanism to temporarily hall movement of a portion of the planter with respect to the frame to maintain a driving plunger horizontally stationary with respect to the ground while the frame is pulled across the ground. In such a planting device, the plunger arm of a hydraulic cylinder can be deployed downward to drivingly engage the tree slips into the ground.

When using a hydraulic plunger arm to push the slips into the ground, the rate at which, the slips are driven downward can be limited to the rate of the plunger arm itself. This can limit the slip planting rate (e.g., the number of slips planted per time), and can employ large amounts of hydraulic power in order to drive the plunger arm downward to a sufficient speed. The rate at which such devices drive the slips can often require preparing the ground soil prior to planting slips, e.g., by using a coulter or other planting preparation process, in order to plant the slips to an appropriate depth.

Such planting devices can also decrease the slip planting rate by limiting the speed at which the planting device frame and/or driving plunger can be moved across the ground in a planting direction, as the pivoting mechanism expands and retracts each time a slip is to be planted. Such planting devices can also be insufficient for planting slips in areas having terrain conditions that are hard, rocky, or dry, among other conditions.

### BRIEF DESCRIPTION OF THE DRAWINGS

Features and advantages of the present, disclosure will, become more apparent from the following detailed description of the embodiments described below in detail with reference to the accompanying drawings where:

FIG. 1 illustrates a planting device according to an embodiment of the present disclosure.

FIG. 2A illustrates a planting device having a recoil unit in a first position according to an embodiment of the present disclosure.

FIG. 2B illustrates the planting device of FIG. 2A having the recoil unit in a second position according to an embodiment of the present disclosure.

FIG. 3 is a side view of the lower portion of a recoil unit according to an embodiment of the present disclosure.

FIG. 4 is a cross-sectional view of a planting device according to an embodiment of the present disclosure.

FIG. 5A is a schematic of a trigger mechanism in a closed position according to an embodiment of the present disclosure.

FIG. 5B is a schematic of the trigger mechanism of FIG. 5A in an open position, according to an embodiment of the present disclosure.

FIG. 6 is a block diagram including a programmable logic controller (PLC) that can be used with various planting device embodiments of the present disclosure.

FIG. 7 is a block diagram of a method embodiment for planting tree slips according to the present disclosure.

FIG. 8A illustrates an encasement insertion structure for planting in accordance with one or more embodiments of the present disclosure.

FIG. 8B is a cross-sectional view of the embodiment illustrated in FIG. 8A.

FIG. 9A illustrates an immature plant element that can be planted in accordance with one or more embodiments of the present disclosure.

FIG. 9B illustrates a structure for forming an encasement insertion structure for planting in accordance with one or more embodiments of the present, disclosure.

FIG. 9C illustrates an encasement insertion structure for planting in accordance with one or more embodiments of the present disclosure.

FIG. 10 illustrates an immature plant element for planting in accordance with one or more embodiments of the present disclosure.

FIG. 11A illustrates an encasement insertion structure for planting in accordance with one or more embodiments of the present disclosure.

FIG. 11B is a cross-sectional view of the embodiment illustrated in FIG. 11A.

### DETAILED DESCRIPTION

The present disclosure includes various method, structure, and device embodiments for planting of tree slips, seedlings, and other immature plant elements in the ground. One embodiment includes an encasement insertion structure for planting that includes an immature plant element having a length and a circumference and an encasing material formed to surround at least a portion of the immature plant element around the circumference for facilitating insertion of the immature plant element through a ground surface.

One method embodiment includes providing a planting device having a frame, the planting device including a generally vertically oriented barrel and a ram slidable within the barrel for propelling a slip having a length placed therein. The method includes accelerating the ram, contacting the slip with, the ram, and propelling the slip to a velocity such that the momentum of the slip is sufficient to fire the slip through an unprepared ground surface such that the slip penetrates the ground surface to a depth of at least 80% of the length of the slip.

In various embodiments, the barrel is fixed with respect to the frame and is moving with respect to the ground surface during the firing of the slip through the ground surface. For example, in various embodiments, a vehicle, such as a tractor, can be attached to the planting device (e.g., with a three point bitch) to move the planter across the ground surface. Embodiments are not limited to a three point attachment. For instance, the planting device can be a floating type that can be raised and lowered with respect to the attached vehicle (e.g., by a hydraulic lift or other lifting mechanism), a semi-floating type that carries some of its own weight (e.g., on wheels or rails), or a trailer type that carries all or nearly all of its own weight.

In such embodiments, the barrel can be translating across the ground surface, e.g., at the speed of the vehicle, while the slip is fired through the ground surface, e.g., the barrel does not remain stationary in the direction of translation of die vehicle, with respect to the ground, when the ram contacts the slip. For example, in some embodiments a tractor can pull the planting device at about 8 feet per second. In such embodiments, various planting device embodiments of the present disclosure can inject, tree slips into the ground in a substantially vertical direction while translating in the direction of travel at the speed of the tractor, e.g., 8 feet per second.

As used herein, substantially vertical includes angles of up to 20 degrees from vertical. However, various planting devices according to the present disclosure can plant tree slips at angles less than 20 degrees from vertical, e.g., 15 degrees, 10 degrees, or 5 degrees or less from vertical. Embodiments are not limited to these examples, e.g., some planting device embodiments of the present disclosure can plant slips at angles greater than 20 degrees from vertical.

In various embodiments, the ram can be in contact with the tree slip until the tree slip penetrates the ground surface to a particular depth, e.g., to a depth of 80% of the length of the slip. In such embodiments, the momentum of the tree slip can be defined as including the momentum of the ram in the calculation, of the momentum of the tree slip. In some embodiments, the momentum of the tree slip is that of the slip itself.

In some embodiments, the ram is not in contact with the tree slip when the slip penetrates the ground surface. In such embodiments, the ram can contact the slip and accelerate the slip to a sufficient velocity such that the momentum of the slip is sufficient to penetrate the ground to an appropriate planting depth without further contact with the ram upon reaching the sufficient velocity. That is, in various embodiments, the ram may or may not be in contact with the tree slip when the tree slip penetrates the ground surface. In some embodiments, the slip is accelerated to a velocity of at least 100 feet per second, 200 feet per second, or 300 feet per second, but embodiments are not limited to a particular tree slip velocity since a sufficient velocity can depend on various factors including, soil conditions and/or type, tree slip dimensions, a suitable/desired planting depth, and/or a translational speed of the vehicle moving the planter, among other factors.

In various embodiments, the tree slips can be cooled slips. That is, in various embodiments, the tree slips can be cooled prior to penetrating the ground. Cooling of the slips can be achieved in a various manners, and the slips can be cooled to various temperatures. For example, in various embodiments, the slips can be cooled to temperatures at or near the freezing point of water. In other embodiments, the slips can be cooled to below or above the freezing point of water.

Cooling the slips can provide various benefits. For example, cooling the slips can increase the rigidity of the slip which may make it less susceptible to bending and/or breaking when being planted. Increasing the rigidity of the slip may allow the slip to be planted to a sufficient depth by accelerating it to a velocity below that used to plant an uncooled slip. The increased rigidity may also allow slips, which may be susceptible to bending/breaking when penetrating the ground surface at a given, velocity, to be planted at that given velocity once the slip is cooled or frozen.

In various embodiments, cooling the tree slip can include freezing the tree slip such that at least a portion of the slip includes ice thereon when it is planted. In some embodiments, a portion of the slip or the entire slip can be encased in ice. The ice formed on and/or around, the frozen slip can be of various thicknesses (e.g., 0.5 millimeters, 1 millimeter, or 2 millimeters, among other thicknesses).

Planting slips having ice thereon can provide various benefits. For example, as mentioned above, the rigidity of the slip can be increased, which can reduce or prevent bending and/or breaking of the slip during planting. Additionally, the ice formed on the slips can provide necessary hydration to the planted slip as the ice melts. In some embodiments, the ice can include various nutrients therein to provide nourishment to the slip as the ice melts.

Various embodiments of the present disclosure can be used to plant seedlings such as conifer seedlings, or other rooted stock. For example, a seedling to be planted can be frozen into a generally cylindrical ice structure such that the frozen structure resembles a tree slip. The generally cylindrical ice structure can have various diameters such as 0.5 inch, 1 inch, or 1.5 inches, among other diameters. In such embodiments, the cylindrically shaped frozen seedling is considered to be a “tree slip” as used herein.

In various embodiments the means for accelerating the ram is a recoil unit. For instance, in various embodiments, the planting device can include a tree slip accelerating unit fixedly attached to the frame in a vertical direction. In such embodiments, the accelerating unit can include a ram movable through a hollow vertical column, e.g., a barrel, and a recoil unit attached to a top end of the ram. In various method embodiments, the method can include tiring the accelerating unit such that the recoil unit moves the ram downward against a tree slip to accelerate the tree slip downward such, that the tree slip is planted substantially vertically into the ground while the accelerating unit is moving across the ground surface at a particular speed. In various embodiments, the accelerating unit is moved across the ground surface at a speed of at least eight feet per second while the accelerating unit is fired.

In various embodiments, a number of tree slips can be planted substantially vertically into the ground at a rate of at least one tree slip per second. In some embodiments, a frame may include more than one planting device, e.g., 2, 4, 6, or more devices, to facilitate planting of more than one row of slips at a time. In such embodiments, a number of tree slips can be planted substantially vertically into the ground at a rate of at least one tree slip per second per row, e.g., 2, 4, 6, or more rows can be planted each second.

In embodiments in which a recoil, unit provides the ram/tree slip accelerating means, the recoil unit can have an upper portion and a lower portion connected by an elastic member, which can move from a stretched to unstretched position to accelerate the ram (and the tree slip after the ram contacts the slip). In various embodiments, the recoil unit can use one or more coil springs or leaf springs (e.g., carbon resin bent leaf springs), among other means to provide the downward acceleration of the ram.

In various embodiments, the planting device can include a lilting mechanism that can have a trigger mechanism attached thereto. In such embodiments, the trigger mechanism can engage a top end of the ram and the upper portion of the recoil unit can be moved upward to a first position, e.g., to a position in which the elastic member is stretched. In some such embodiments, the accelerating unit can then be fired, e.g., by disengaging the trigger mechanism from the ram such that the ram is propelled, downward to a second position, e.g., to a position in which the elastic member is unstretched, by a recoil force of the recoil unit. In some embodiments, the accelerating unit can be fired by moving the trigger mechanism against a disengagement member as described further below.

In various embodiments, the downward recoil force can move the upper portion of the recoil unit and/or the ram at various rates depending on factors such as the composition, of the elastic member and/or the distance that the elastic member is stretched, among various other factors. As an example, the composition of the elastic, member can be natural rubber or an elastomeric polymer, among other compositions, and the elastic member can be stretched various distances such as 6 inches 9 inches, or 12 inches, among other distances. In some embodiments, the downward force can accelerate the ram to a rate of 230 feet per second. However, embodiments are not limited to these exemplary compositions, distances, or rates. For instance, in various high speed planting device embodiments, the ram can be accelerated to various speeds above and/or below 230 feet per second in order to plant tree slips.

In various embodiments, a tree slip is delivered, in a vertical position, to a slot in the bottom end of the barrel prior to the accelerating unit being fired. Also, in some embodiments, the accelerating unit is fired such that a bottom end of the ram is not more than 2 inches from an upper end of the tree slip when, the accelerating unit is fired, (e.g., the separation distance between the slip and ram at the time of firing is less than two inches). Embodiments are not limited to a particular separation distance, as the appropriate distance can vary depending on various factors including the acceleration, of the ram, the size of the slip, etc.

Embodiments of the present disclosure are not limited to planting methods and/or devices in which the means for accelerating the ram is a recoil unit. For instance, the means for accelerating the ram, e.g. firing an accelerating unit, can be compression of a gas such as air or combustion of a gas, such as propane or diesel fuel, or a combustible gas mixture.

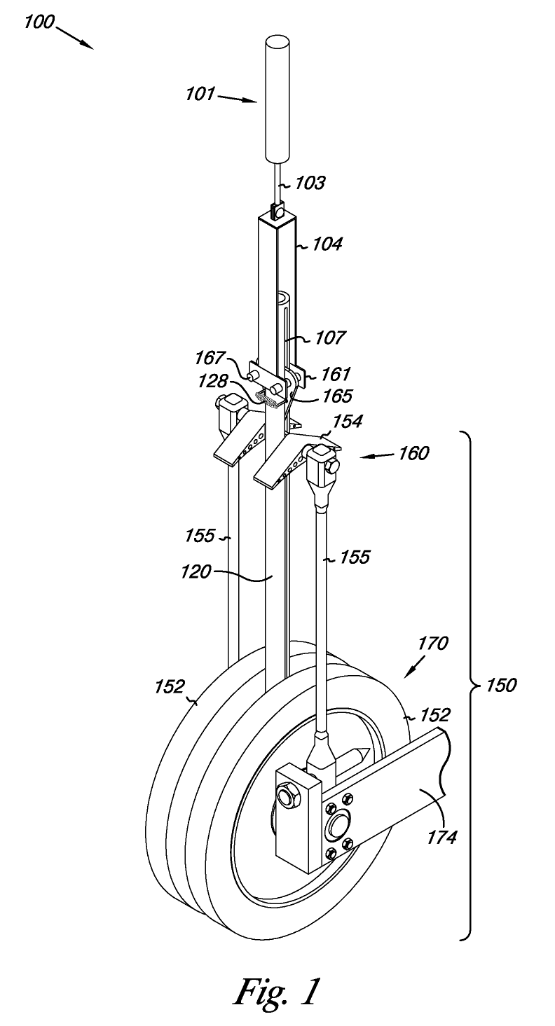

FIG. 1 illustrates a planting device according to an embodiment of the present disclosure. In this embodiment, the planting device 100 includes a lifting unit 101, a hollow vertical column, e.g., a barrel 320, and a recoil unit 150.

In the embodiment illustrated in FIG. 1, the lifting unit 101 includes a hydraulic cylinder which can be mounted to the frame of the planting device in a vertical direction. In this embodiment, the plunger arm 103 (piston) of the hydraulic cylinder is attached to a pair of elongate parallel, plates 304. Each of the pair of elongate parallel plates is attached to a face plate 161, between which a trigger mechanism 165 is pivotally mounted for pivoting about pins 167. As used herein, a recoil unit, e.g., recoil unit 150, and a trigger mechanism, e.g., trigger mechanism 165 may be referred to collectively as a “tree slip accelerating unit,” or simply as an “accelerating unit.”

Embodiments of the present disclosure are not limited to a lifting unit that includes a hydraulic cylinder. For example, the lifting unit can include a pneumatic lifting mechanism or other lifting mechanism.

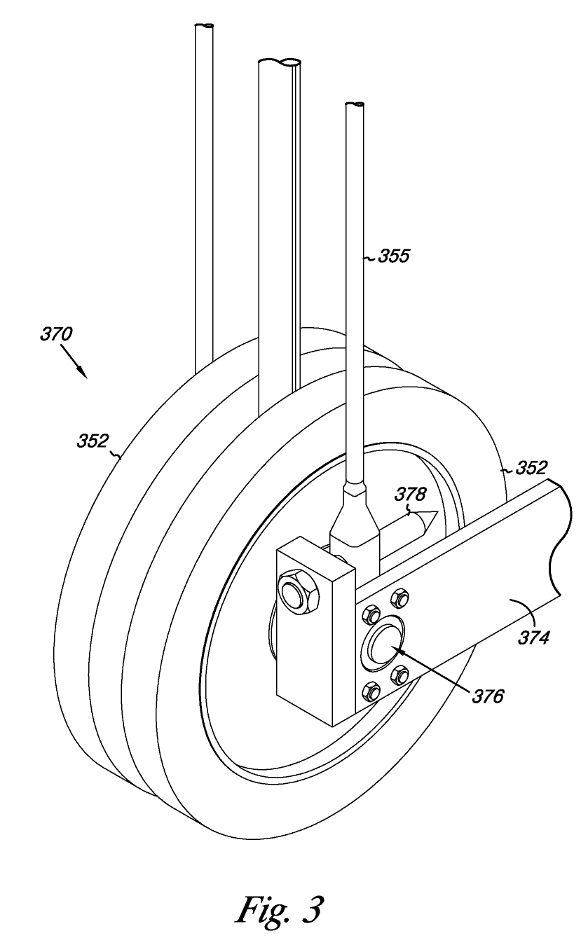

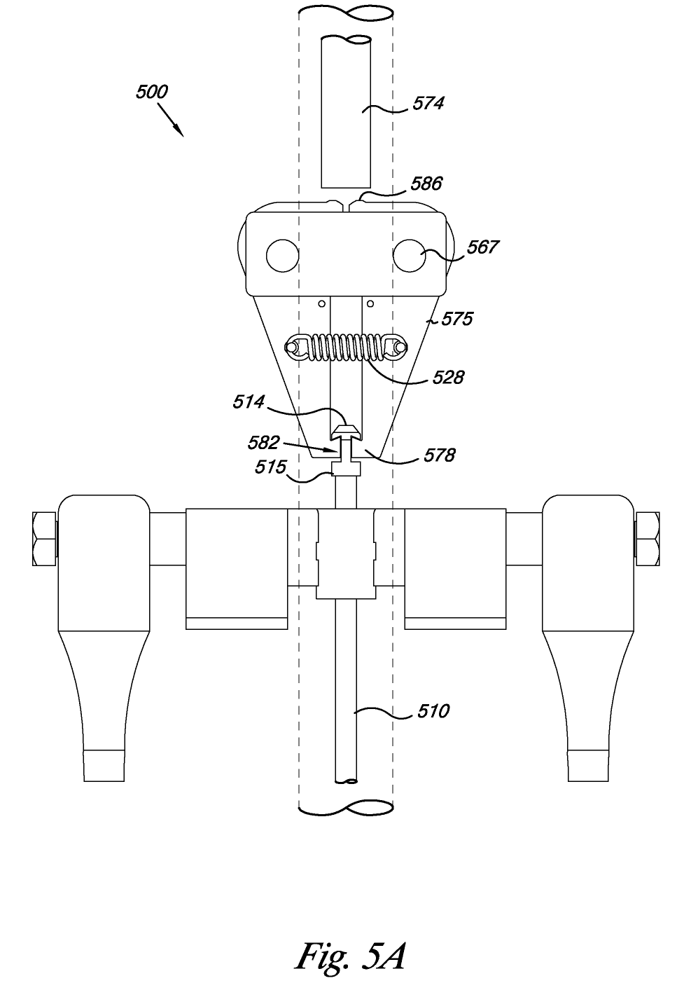

In various embodiments, the trigger mechanism 165 can be slidably attached to the hollow vertical barrel 120 for vertical movement thereon. In the embodiment illustrated in FIG. 3, barrel 120 includes vertical side slits 107 in which the trigger mechanism 165 can move. The trigger mechanism can be force biased to a closed position with a spring 128 or other tension, providing member and can pivot between an open and closed position. A trigger mechanism embodiment, is described in greater detail below in connection with FIG. 5A-5B.

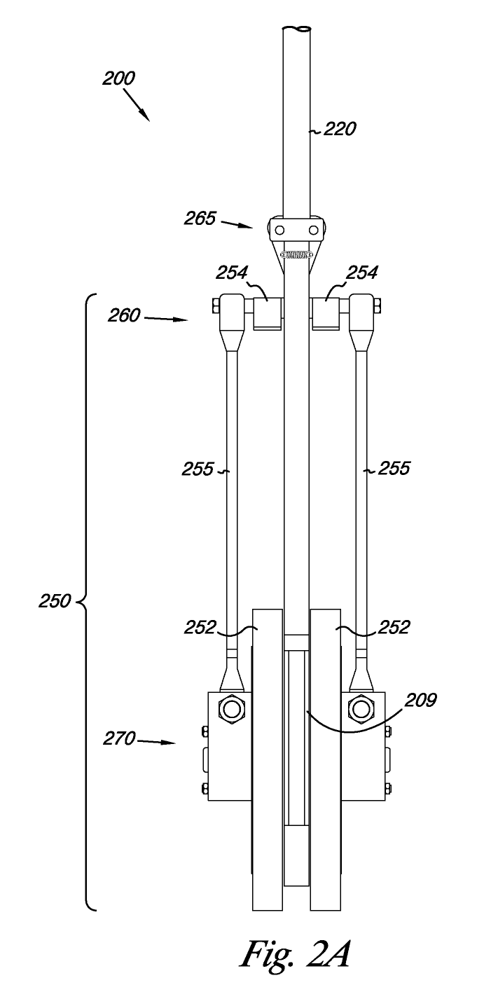

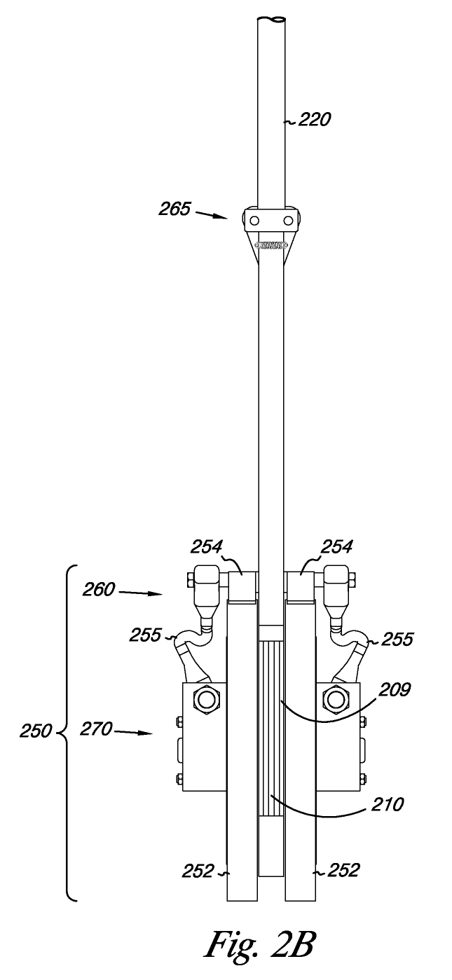

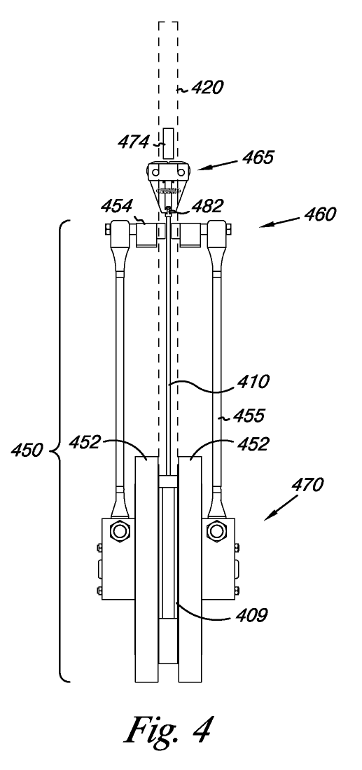

In the embodiment illustrated in FIG. 1, the recoil unit 150 is positioned near a lower end of the barrel 120. In this embodiment, the barrel includes a tree slip receiving slot (shown in FIGS. 2A-2B) to receive tree slips, hi various embodiments, a ram (shown in FIGS. 4 and 5A-5B) passes vertically through the barrel to contact tree slips and accelerate them to a velocity such that the momentum of the slips is sufficient to fire the slips through the ground surface to an appropriate depth, e.g., to a depth below the surface of about 80% or 90% of the length of the slips. In various embodiments, the ram remains in contact with the slip such that the momentum of the ram can be used to push the slip into the ground to the proper depth.

As described in FIGS. 4 and 5A-5B, the ram can have various lengths (e.g., > 8 inches, 12 inches, 20 inches), diameters (e.g., 1 inch, 1.25 inches, 1.5 inches), compositions (e.g., various metals or plastics), and shapes (e.g., an elongate cylinder), which can depend on various factors including the size of the tree slips or downward acceleration of the ram, among other factors.

The planter embodiments of the present disclosure can be used, to plant tree slips of varying sizes substantially vertically into the ground. For instance, the tree slips can have diameters of about 0.25-1.0 inches and lengths of about 8-20 inches; however, embodiments are not limited to tree slips having these dimensions.

In various embodiments, and as shown in the embodiment of FIG. 1, the recoil unit 150 includes an upper portion 160 slidably attached to the barrel 120 for vertically moving thereon between a first position and a second position. In various embodiments, and as more clearly shown in FIGS. 4 and 5A-5B, the upper portion 160 of the recoil unit 150 can be attached to the ram near a top end of the ram.

As illustrated in the embodiment of FIG. 1, the recoil unit 150 can include an elastic member 155 attached from the upper portion 160 to a lower portion 170 of the recoil unit for providing a downward recoil force to move the upper portion from the first to the second position, as discussed further below in connection with FIGS. 2A-2B. As mentioned above, the elastic member can be made of a dense rubber or various other elastic materials having high spring constants.

In various embodiments, the lower portion of the recoil, unit can be mounted to the frame of the planting device such that the lower portion is fixed in the vertical direction and can include a stop to prevent the upper portion from moving past the second position in a downward, vertical direction. In the embodiment illustrated in. FIG. 1, the lower portion of the recoil unit is mounted to a portion of the frame 174. Although only a portion of the frame is shown, the reader will appreciate, that the frame of planting device 100 can be attached to the device at various oilier locations on the device to provide stability during planting. Furthermore, the frame can be attached to a number of planting devices 100, e.g., 2 or more, and the frame may not be connected to a lower portion of the recoil unit as shown in the embodiment of FIG. 1.

In the embodiment illustrated in FIG. 1, the lower portion stop is a pair of shock absorbing rubber wheels 152. In such embodiments, the lower portion stop can receive the upper portion of the recoil unit when the accelerating unit is fired, e.g., when the ram is released by the trigger mechanism, to prevent the upper portion from moving past the second position. In various embodiments, the shock absorbing wheel can be made of highly dampened rubber or other suitable shock absorbing materials.

In various embodiments, the shock absorbing wheel or wheels can be rotatably mounted to the frame. In such embodiments, the wheel can be positioned such that rotation is provided by the ground as the planting device moves across the ground surface, or the wheel, can be positioned off the ground with rotation being provided by a motor or other suitable means. The wheel or wheels can have an axis of rotation that is horizontal or slightly tilted from horizontal and may act to pack the soil around the tree slip in embodiments in which the wheel is moved across the ground surface.

In various embodiments, the upper portion of the recoil unit can also include a stop. In such embodiments, the stop of the upper portion can engage the slop of the lower portion to prevent, the upper portion from moving past the second position. Preventing the upper portion from moving past the second position can facilitate a suitable planting depth of the tree slip by limiting the distance that the ram moves.

As an example, the lower stop can be positioned such that the bottom of the ram is a particular distance above the ground when the upper portion of the recoil unit is in the second position (e.g., when the recoil unit is unstretched and the downward motion of the ram is stopped). For instance, in some embodiments, the lower stop is positioned such that the ram is about one inch above the ground surface when the upper portion of the recoil unit is in the second position. In some such embodiments, free slips can be planted to a depth of one inch above the surface. That is, the ram can remain in contact with the slip until the slip is planted to a depth such that one inch of the slip remains above the ground surface.

In this embodiment, the upper portion stop of the recoil, unit 150 is a pair of metal shock shoes 154 having a concave lower surface. The curvature of the shock shoes can facilitate suitable heat, transfer as the shoes engage the shock absorbing wheels each time the upper portion is moved from the first to the second position by the elastic member. Embodiments are not limited to the number of, composition of, or type of stops.

In various embodiments, the lifting device 101 can be used to tower the trigger mechanism 165 for engaging the top end of the ram as shown in FIGS. 4 and 5A-5B and can be used to raise the upper portion 160 of the recoil unit 150 to the first position (e.g., to a position in which the elastic member 155 is stretched as shown in FIG. 2A).

In various embodiments, the accelerating unit is tired, e.g., the trigger mechanism disengages the ram, when the upper portion of the recoil unit reaches the first position allowing the downward recoil force to propel the upper portion downward to the second position (e.g., a position in which the elastic member 155 is unstretched as shown in FIG. 2B) such that the ram contacts the tree slip and accelerates the slip downward such that the tree slip is planted substantially vertically into the ground.

In various embodiments, the accelerating unit is fired while the accelerating unit (e.g., barrel 120, recoil unit 150, and trigger 165) is moving across the ground surface. That is, in various embodiments, the accelerating unit does not stop translating with respect to the ground surface. In various embodiments, the accelerating unit remains stationary in the horizontal plane with respect to the frame as the planting device translates across the ground surface. In is noted that portions of the accelerating unit such as the ram and recoil unit may move with respect to the frame and ground in the vertical plane despite remaining stationary with respect to the frame in the horizontal plane.

In various embodiments, firing the accelerating unit causes the ram to accelerate tree slips downward to a rate, e.g., a velocity, of at least 200 feel per second. Embodiments are not so limited. That is, in various embodiments, firing the accelerating unit can cause the ram to accelerate tree slips downward to rates less than 200 feet per second.

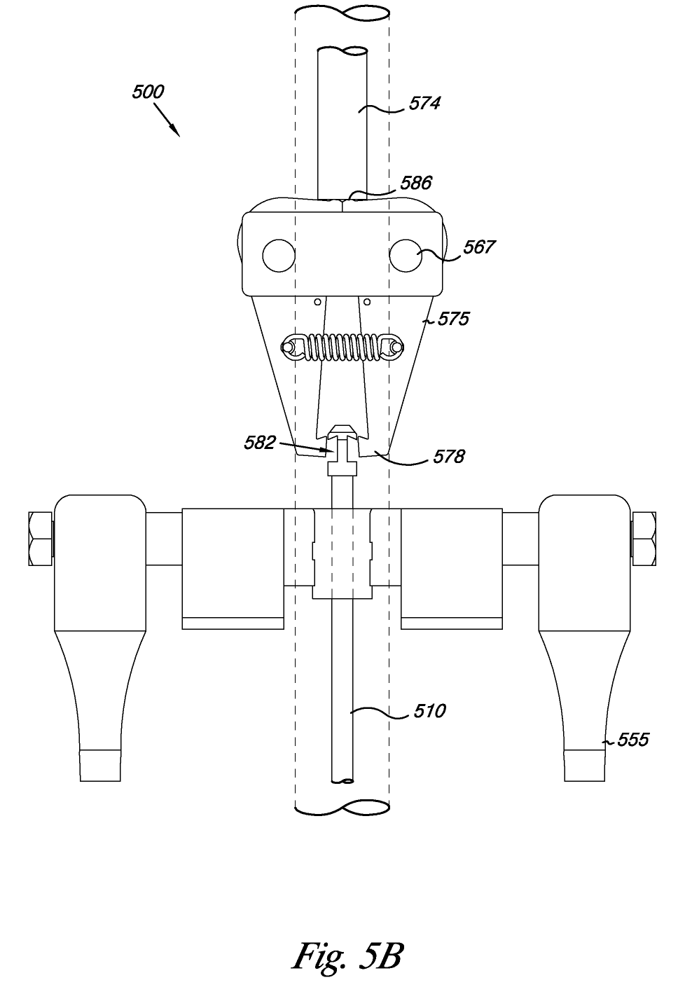

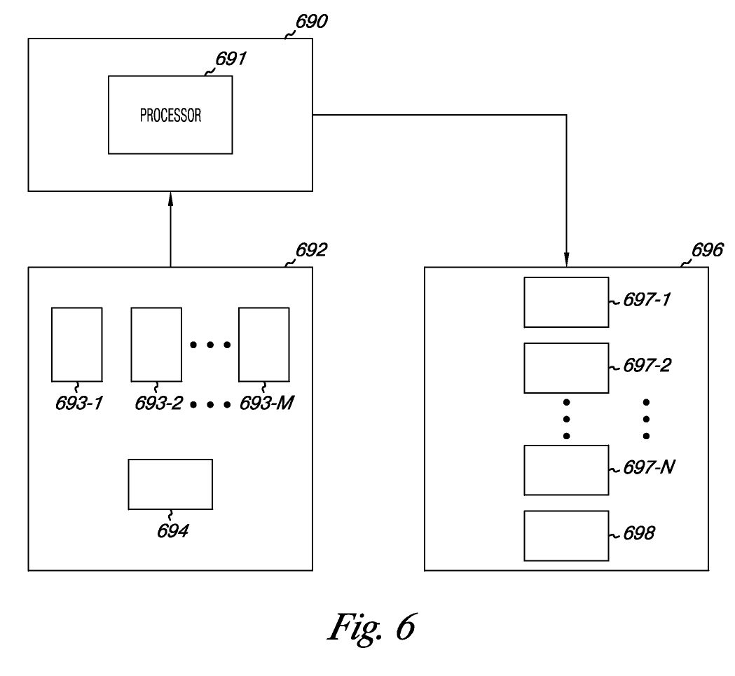

In various embodiments, and as described below in connection with FIG. 6, the operation of the planting device can be controlled with one or more programmable logic controllers (PLCs). The PLCs can receive electrical inputs from, various sensors (e.g., proximity sensors, motion sensors, and/or temperature sensors, among other sensors) and other electrical components (e.g., switches) that can be located at various locations on or around the planting device. The various sensors can provide information to the PLC as to the physical position and or speed of the ram and/or the trigger mechanism (e.g., trigger 165), the presence of a tree slip in a receiving slot, and/or the position/orientation of the tree slip upon being fired into the ground, among various other information. The PLCs can also use various received input signals to control various output components, such as electromechanical valves to operate the hydraulics associated with the lifting unit, recoil, unit, and/or slip feeder, among other hydraulic components. For example, the PLC can control the hydraulic cylinder 101 to lower the trigger mechanism 165 to engage the ram and to raise the trigger mechanism 165.

As illustrated in FIG. 1, in various embodiments, the plunger 103 of the hydraulic cylinder 101 of planting device 100 is not used as the ram to inject the tree slips into the ground. Using a hydraulic plunger to accelerate the ram into contact with the slip may prevent the slip from reaching a sufficient velocity as the downward acceleration of the ram may be limited, which can result in slip bending and/or breakage. In various embodiments, and as discussed herein, the hydraulic cylinder plunger 103 can be used to lower the trigger mechanism 165 in order to engage the ram. The plunger 103 can also be used to raise the ram 110 (i.e., the ram engaged to the trigger mechanism) to a position at which the accelerating unit is fired, e.g., the ram is disengaged from the trigger mechanism, in order to accelerate a tree slip to a velocity such that the momentum of the slip is sufficient to fire the slip thorough the ground surface to a sufficient planting depth. In such embodiments, hydraulic power can be saved and/or conserved since hydraulic power is not used to rapidly accelerate the hydraulic plunger downward.

As mentioned above, in various embodiments, the planting device 100 can plant tree slips vertically into the ground while the vertical barrel 120 is fixed with respect to the frame and is moving with respect to the ground surface as the planting device translate across the ground. For example, in one embodiment, the planting device 100 can be pulled behind a tractor (not shown) at a rate of about 8 feet per second. In such an embodiment, the planting device 100 can propel the tree slips substantially vertically into the ground as the frame, vertical barrel, and ram maintain the translational speed of the tractor (e.g., 8 feet per second). In such embodiments, accelerating means, e.g., an elastic member or gas combustion, can accelerate the ram to a speed of about 230 feet per second when the trigger mechanism 165 is disengaged from the ram at the first position, e.g., when the accelerating unit is fired.

In some embodiments, it may be beneficial to change the downward speed the ram and/or slip reaches by changing the accelerating means. One such benefit of embodiments of the present disclosure includes the ability to reduce and or prevent the bending or breaking of slips, which may occur if the slips are not accelerated to a sufficient speed, e.g., a speed above 200 feet per second, depending on various factors. As one example, changing the accelerating means includes changing the size and/or composition of the elastic member and/or the distance between the first and second position (e.g., how much the elastic member is stretched prior to recoiling upon disengagement of the trigger mechanism). A suitable downward ram speed can depend on various factors including the translational speed of the planter (or tractor) across the ground, the diameter of the tree slips, or the type of soil among other factors.

As an example of determining a suitable downward ram speed, or downward slip speed, consider a planting device that is to plant a 12 inch slip per second while the device is translating at 8 feet (e.g., 96 inches) per second. Assume that the slip will be damaged (e.g., break or kink) if the device translates more than 0.5 inch from the time the slip penetrates the ground surface until the slip is planted to the appropriate depth (e.g., 10 inches) in the ground. In this example, in order to prevent tire slip from being damaged, the slip must be planted to the 10 inch depth in about 5 milliseconds. Therefore, a suitable downward speed of the slip into the ground would be at least 2,000 inches (e.g., 170 feel) per second in order to plant the slip to a 10 inch depth without damaging the slip. It is noted that this example suitable downward ram speed can depend on various factors such as the soil type, slip dimensions, desired slip planting rate, and/or the translational speed of the device, among other factors.

In embodiments in which a combustible gas or gas mixture is used to accelerate the ram, the downward speed of the ram can depend on various factors that can be adjusted such as the type/composition or pressure of the gas, among other factors.

As mentioned above, the speed to which planting various planting device embodiments of the present disclosure, e.g., planting device 100, can accelerate tree slips in order to sufficiently plant them vertically in the ground can reduce or eliminate the need to prepare the ground surface. For instance, in various embodiments, the recoil unit 150 of the planting device can propel tree slips downward to speeds, e.g. over 100 feet per second, sufficient to plant slips without using a trench forming device such as a coulter wheel, for example.

In various embodiments, a planting system can include more than one planting device. For example, in one embodiment, a frame of the planting system includes six planting devices laterally spaced apart such that six rows of tree slips can be planted. In such embodiments, the planting devices can be configured to plant a tree slip at a rate of about 1 tree slip per second per row, such that the system can plant about six slips per second. The planting devices may be operated in concert with each other or individually (e.g., some or all of the planting devices may accelerate tree slips downward at the same time). In some system embodiments, the multiple planting devices can be positioned on a planting system frame having a “V” design as is understood by those of ordinary skill in the art.

In various embodiments of the present disclosure, the planter can include a hopper to stop several tree slips to be planted. The slips can be received to a receiving slot (e.g., slot 209 as shown in FIGS. 2A-2B) of the barrel 120 from a tree slip feeder. In one embodiment, the tree slip feeder can include a pair of parallel plates spaced apart a suitable distance (e.g., 0.75 inches, 1 inch, 1.5 inches) so as to fit between the shock absorbing slops of the recoil, mechanism to deliver the > slips in a vertical orientation to a slot (e.g., slot 209 as shown in. FIGS. 2A-2B) in the barrel. In various embodiments, the tree slip feeder can be hydraulically operated and controlled by a PLC of the planting device.

In various embodiments, the slips received to the barrel can be accelerated downward without being vertically supported. That is, in various embodiments, the planter is configured such that the trigger mechanism is fired (e.g., opened or disengaged) nearly simultaneously with the slip being delivered to the barrel (e.g., after a short delay of 0.15 seconds, 0.2 seconds, 0.25 seconds, or 0.30 seconds, among other time delays). In such embodiments, this short time delay coupled with the fact that the ram can be accelerated downward by the recoil force of an elastic member to speeds of about 200-250 feet per second, can cause the ram to contact the lop end of the slip prior to the slip falling a substantial distance clue to gravity.

As previously mentioned, the frame can be attached to, and/or pulled behind, a vehicle, e.g., a tractor. In such embodiments, the vehicle may include various components such as hydraulic pumps and/or motors to operate various components of high speed planting devices 100 (e.g., lifting unit 101, recoil unit 150, and/or a tree slip feeder, among other components).

Also, in some embodiments, the planter and/or a vehicle to which it is attached, can include a global positioning system (GPS) to accurately determine the real-lime position and/or velocity of the vehicle and/or planter. In such embodiments, signals can be generated by the GPS and sent to a PLC of the planting device to cause the device to plant tree slips at predetermined locations or coordinates. In various embodiments, the GPS velocity can be input to the PLC circuitry and used in timing when the planting device(s), or accelerating unit thereof, is to be fired, i.e., when the trigger is to be opened, or disengaged from the ram.

FIGS. 2A and 2B illustrate a planting device having a recoil unit in a first position and a second position, respectively, according to an embodiment of the present disclosure. In the embodiment illustrated in FIG. 2A-2B, the recoil unit 250 includes an upper portion 260 slidably attached to a hollow vertical column, e.g., barrel 220, and a lower portion 270 rotatably mounted to the frame of the planting device 200 in a fixed vertical position. In this embodiment, the recoil unit 250 includes an elastic member 255 attached from the upper portion 260 to the lower portion 270 for providing a downward recoil force to accelerate the upper portion from the first position (FIG. 2A) to the second position (FIG. 2B).

As discussed below in connection with FIGS. 4 and 5A-5B, the upper portion 260 can be attached to a ram which can be engaged with a trigger mechanism 265 at the ram's top end (e.g., a trigger catch 682 as shown in FIGS. 5A-5B) and raised to the first position as shown in FIG. 2A. The trigger mechanism can then be fired, e.g., disengaged from the ram, allowing the elastic member 255 to recoil, rapidly pulling the upper portion 260 (and ram) downward until a stop 254 of the upper portion engages a stop 252 of the lower portion at the second position as shown in FIG. 2B.

Embodiments of the present disclosure are not limited to the recoil unit shown in FIGS. 2A and 2B. For example, the ram 210 (e.g., the upper portion 260) can be accelerated downward by a means other than the elastic member 255 shown. In various embodiments, the elastic member can be one or more coil springs and/or leaf springs having high enough spring constants to provide a downward acceleration of the ram sufficient to plant, tree slips.

In the embodiment illustrated in FIG. 2B, a portion of the ram 210 is shown as extending vertically through slot 209. The ram is shown in detail in connection with FIGS. 4 and 5A-5B.

FIG. 3 is a side view of the lower portion of a recoil unit according to an embodiment of the present disclosure. In the embodiment shown in FIG. 3, the lower portion 370 of the recoil unit includes a pair of shock absorbing wheels 352. In this embodiment, each wheel is rotatably mounted to a bracket 374 that can be attached to the frame such that each wheel can rotate about an axle 376. In this embodiment, the wheels are positioned so as to rotate along the ground during operation of the high speed planting device. In some embodiments, the shock absorbing wheels may not be rotatably mounted and/or may be positioned off of the ground surface during planting operations.

In the embodiment illustrated in FIG. 3, the bracket 374 includes a pin 378 to which an elastic member 355 is attached. The elastic member can be attached to the lower portion 370 in various manners and at various oilier locations.

FIG. 4 is a cross-sectional view of a planting device according to an embodiment of the present disclosure. In the embodiment of FIG. 4, the planting device includes a barrel 420 through which the ram 430 moves. The embodiment of FIG. 4 also includes a recoil unit 450 as described above.

As shown in the embodiment of FIG. 4 and as described below in connection with FIGS. 5A-5B the upper portion 460 of the recoil unit can be attached to a top end of the ram 410. In various embodiments, and as illustrated in FIG. 4, the upper portion 460 of the recoil unit is attached below a trigger catch 482 at a top end of the ram 410. The trigger catch 482 can be engaged/disengaged to/from a trigger mechanism 465. The interaction of the trigger catch and trigger mechanism is discussed further in connection with FIGS. 5A-5B below.

In the embodiment shown in FIG. 4, the vertical barrel 420 includes a tree slip receiving slot 409 at a lower end of the barrel. During operation of various planter embodiments, tree slips are received in a vertical orientation to the slot 409 from a tree slip feeder (not shown) and are propelled to a velocity such that the momentum of the slip is sufficient to lire the slip through an unprepared ground surface such that (lie slip penetrates the ground surface to a suitable/desired depth.

For example, the upper portion 460 can be moved vertically upward to a first position (e.g. the position shown in FIG. 2A), creating a tension in the stretched elastic member 455. The trigger mechanism can then be disengaged from the trigger catch 482 of the ram 410 such that the upper portion 460 (and ram 410) is rapidly pulled downward to a second position (e.g., the position shown in FIG. 2B) at which the shock shoes 454 engage the shock absorber 452 of the lower portion 470 of the recoil mechanism. Disengagement or tiring, of the trigger mechanism can occur as the top end of the trigger mechanism is moved upward against a disengagement member 474. The disengagement member 474 can be a cylindrical member mounted inside the vertical barrel 420, as shown in FIGS. 4 and 5A-5B. Alternatively, the PLC could be used to control the opening/closing (i.e., the engaging/disengaging, or tiring) of the trigger mechanism.

FIGS. 5A and 5B illustrate an embodiment of a trigger mechanism in a closed and open position, respectively. In the embodiment illustrated in FIGS. 5A and 5B, the trigger mechanism 500 includes a pair of trigger plates 575 which can engage the top end of an elongate ram 510.

Each trigger plate 575 has an opening that receives a pin 567 therethrough about which the plates can pivot to engage and disengage the ram 510. As illustrated in this embodiment, each plate 575 includes a tooth 578 which can engage a trigger catch 582, or notch of the ram 510.

In this embodiment, the trigger catch 582 is formed, between the rounded top end 584 of the ram and an enlarged diameter portion 515 of the ram 510. The trigger plates 575 can be force biased in a closed position with a spring, e.g., a coil spring 528 as shown in FIG. 1, or another suitable spring. As the closed, plates 575 are moved downward against the rounded end 584 of the ram, the plates open slightly as the spring force is overcome enough that the plates pivot about pins 567 such that the teeth 578 engage the trigger catch 582 as the plates are forced downward.

As illustrated in the embodiment of FIG. 5A, each trigger plate 575 can include a protrusion 586 that can engage a release member 574 as the trigger mechanism 500 is moved upward in order to disengage (open) the trigger plates 575 as shown in FIG. 5B. That is, from the closed (engaged) position shown in FIG. 5A, the ram 510 can be moved upward to a suitable distance from which it can be released, to accelerate downward and contact a tree slip to accelerate the tree slip to a velocity such that the momentum of the slip is sufficient to propel the slip through a ground surface such that the slip penetrates die ground to a suitable planting depth.

FIG. 5B is a schematic of the trigger mechanism of FIG. 5A in an open (disengaged) position. In the embodiment of FIG. 5B, the trigger mechanism 500 has been moved upward such that the protrusions 586 of the trigger plates 575 have engaged the release member 574. The interaction of the protrusions 586 with the release member 574 causes the trigger plates 575 to pivot outward about pins 567 thereby disengaging teeth 578 from the trigger catch 582. As discussed herein, disengaging the trigger mechanism 500 at a raised position causes the ram 510 to be accelerated downward by the force of the elastic member 555, as discussed in connection with FIG. 1, for example. Embodiments of the present disclosure are not limited to the trigger mechanism described in FIGS. 5A-5B.

FIG. 6 is a block diagram including a programmable logic controller (PLC) that can be used with various high speed planting device embodiments of the present disclosure. As shown in the embodiment of FIG. 6, the PLC 690 can be electrically coupled to various input components 692 and output components 696 of a planting device (e.g., planting device 100 shown in FIG. 1). In operation, the processor 691 of the PLC can receive electrical signals from the input components which can be used to monitor and/or control the various output components.

As shown in the embodiment of FIG. 6, the input components 692 can include a number of sensors 693-1, 693-2, . . . 693-M, among various other logic circuitry 694. The indicator “M” is used to illustrate that the input components can include any number of sensors. The sensors 693-1 to 693-M can include various proximity, motion, and/or temperature sensors, among other types of sensors. The sensors can be located at various locations on and/or around the planting device. For instance, sensors can be positioned to determine the vertical location and/or speed of the ram (e.g., ram 410), and/or to determine the presence of a tree slip (e.g., in receiving slot 409) and/or its orientation and depth after being planted. The logic circuitry 694 can include a number of switches (e.g., relays) that can perform various functions such as signaling the PLC when the trigger mechanism and/or recoil unit reaches or passes a certain vertical distance, e.g., when to fire the accelerating unit, for example.

As shown in the embodiment of FIG. 6, the output components 696 can include a number of electromechanical control valves 697-1, 697-2, . . . 697-N, among various other logic circuitry 698. The indicator “N” is used to illustrate that the output components can include any number of control valves. The control valves 697-1 to 693-N can include solenoid valves, among other types of electromechanical valves.

In various embodiments, the control valves 697-1 to 697-N can be controlled by the PLC to operate various hydraulic components of the planting device. For example, the control valves can be controlled to start and/or stop hydraulic fluid flow in order to raise and/or lower the plunger arm of a hydraulic cylinder (e.g., a hydraulic cylinder of lifting device 101 as shown in FIG. 1) to raise and lower the trigger mechanism of the planting device. Other hydraulic cylinders that may be associated with the tree slip feeder and/or a three point hitch can also be controlled by the PLC.

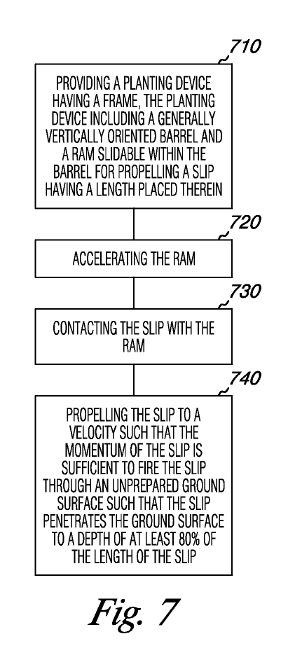

FIG. 7 is a block diagram of a method embodiment for planting tree slips according to the present disclosure. At block 710, the method includes providing a planting device having a frame, the planting device including a generally vertically oriented barrel and a ram slidable within the barrel for propelling a slip having a length placed therein.

At block 720, the method includes accelerating the ram. As described herein, the means for accelerating the ram can be a recoil unit, e.g., recoil unit 250 as described in. FIGS. 2A and 2B. The means for accelerating the ram are not limited to such recoil units. For example, the means for accelerating the ram can be a combustible gas which can be ignited or compressed to create an explosion which, forces the ram downward.

At block 730, the method includes contacting the slip with the ram. At block 740, the method includes propelling the slip to a velocity such that the momentum of the slip is sufficient to fire the slip through an unprepared ground surface such that the slip penetrates the ground surface to a depth of at least 80% of the length of the slip. In some embodiments, the slip is propelled to a velocity such that the momentum of the slip is sufficient to fire the slip through an unprepared ground surface such that the slip penetrates the ground surface to a depth, of at least 90% of the length of the slip. In some embodiments, the method includes stopping the ram such that the slip is not in contact with the ram when penetrating the ground surface.

In various method embodiments, the barrel is fixed with respect to the frame and is moving with respect to the ground surface during the firing of the slip through the ground surface. Also, in various embodiments, the method can include providing a vehicle to move the planting device across the ground surface. In such embodiments the method can include contacting the slip with the ram while the barrel is moving across the surface, e.g., the barrel is not stationary with respect to the ground surface when the ram contacts the slip.

In various method embodiments, the method can include providing a planting device that includes a tree slip accelerating unit fixedly mounted to a frame of the device in a vertical direction. In such embodiments, the accelerating unit can include a ram movable through a barrel, and a recoil unit attached to the top end of the ram. In such embodiments, the method can include firing the accelerating unit such that the recoil unit moves the ram downward against a tree slip to accelerate the tree slip downward such that the tree slip is planted substantially vertically into the ground while the accelerating unit is moving across the ground surface at a particular speed. As described above, one or more planting devices can be attached to a frame and moved across the ground surface at a speed of about 8 feet per second by a vehicle.

The above methods, structures, and devices can be utilized with tree slips and other immature plant elements as described herein. Additionally, although various embodiments of planting devices and methods are discussed above, the encasement insertion structures described, herein can also be utilized in other suitable types of devices or methods for planting immature plant elements.

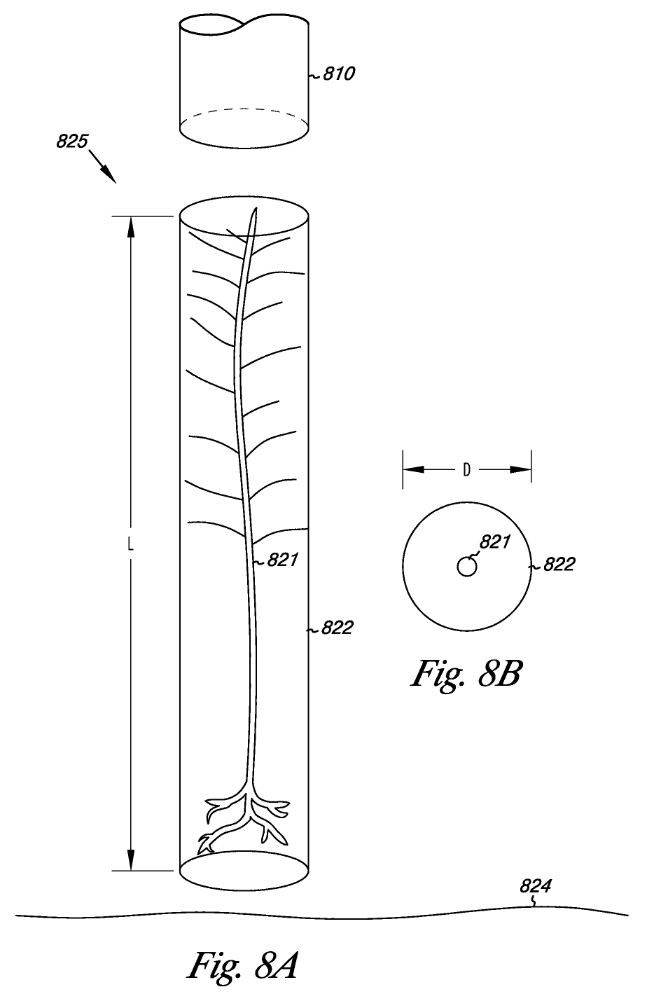

FIG. 8A illustrates an encasement insertion structure 825 for planting in accordance with one or more embodiments of the present disclosure. FIG. 8B is a cross-sectional view of the embodiment illustrated in FIG. 8A. In one or more embodiments, an encasement insertion structure for planting includes an immature plant element, having a length and a circumference. In the embodiment illustrated in FIGS. 8A and 8B, the structure 825 includes an immature plant element 821.

As used herein, the term “immature plant element” can refer to a seed, a seedling, or a slip (e.g., a roofed or non-rooted cutting), among various other immature plant elements that can be inserted in a ground surface. As examples, in one or more embodiments, an immature plant element can include a conifer seedling, a ficus tree cutting, and a eucalyptus seedling, among others. For instance, in the embodiment illustrated in FIGS. 8A and 8B, the immature plant element is a conifer seedling 821.

The encasement insertion structure can include an encasing material formed to surround at least a portion of the immature plant element around the element's circumference for facilitating insertion of the immature plant element through a ground surface. For instance, in the embodiment illustrated in FIGS. 8A and 8B, the encasing material 822 is illustrated as being formed around the circumference of plant element 821 along its entire length (L).

Embodiments are not so limited. For example, in one or more embodiments, the encasing material, (e.g., 822) may be formed around less than the entire circumference of the immature plant element and/or may be formed along less than its entire length. Forming the encasing material around less than the entire circumference of the immature plant element may provide benefits such as facilitating growth of the element after planting, among other benefits. In one or more embodiments, the length (L) of the immature plant element (e.g., 821) is at least six inches.

In various embodiments, preparing an immature plant element for planting can include encapsulating at least a portion of the immature plant element in an encasing material having sufficient, rigidity to maintain a structural integrity of the immature plant element during penetration of the ground surface. In some such embodiments, the encasing material (e.g., 822) can, for example, mechanically stabilize the immature plant element, which can provide benefits such as preventing damage to the plant element during planting (e.g., upon penetration through a ground surface 824), among other benefits.

The encasing material (e.g., 822) can be formed of various materials. For example, the encasing material 822 can include one or more organic and/or inorganic materials and/or combinations thereof.

In various embodiments, the encasing material 822 can include plant nutrients therein. The nutrients can include macro nutrients such as nitrogen, phosphorus, calcium, magnesium, potassium, and/or sulfur and/or micronutrients such as boron, copper, chloride, iron, and/or zinc, among various other nutrients. Providing nutrients in the encasing material can provide nourishment to the immature plant element upon planting, which, can facilitate proper growth of the element.

As one example, the encasing material 822 can include a fertilizer containing one or more of the various nutrients. The fertilizer can be an organic fertilizer such as cottonseed meal, blood meal, fish emulsion, manure, peat, grass clippings, leaves, etc., and/or can be an inorganic fertilizer. Other nutrients or nutrient containing materials which may be included in an encasing material (e.g., 822) can include sugar, wheat protein, corn starch, various keratins, and/or pasta, among others.

In various embodiments, the encasing material 822 can include an organic and/or inorganic adhesive material. In various embodiments, the adhesive material can be solid at room temperature. In various embodiments, the adhesive material can be used to bind other materials contained in the encasing material 822, e.g., sand, soil, sawdust, etc. The adhesive material can be water soluble, in some embodiments. In such embodiments, the adhesive material can mechanically stabilize the immature plant element during planting and can then degrade upon contact with water to facilitate growth of the immature plant element.

In one or more embodiments, the encasing material (e.g., 822) can be a frozen material (e.g., at least a portion of the encasing structure can be frozen). In one or more embodiments, the frozen encasing can include ice combined with one or more other materials. For instance, in one or more embodiments, a frozen encasing can include materials such as soil, sand, fertilizer, and/or sawdust, among other materials (herein.

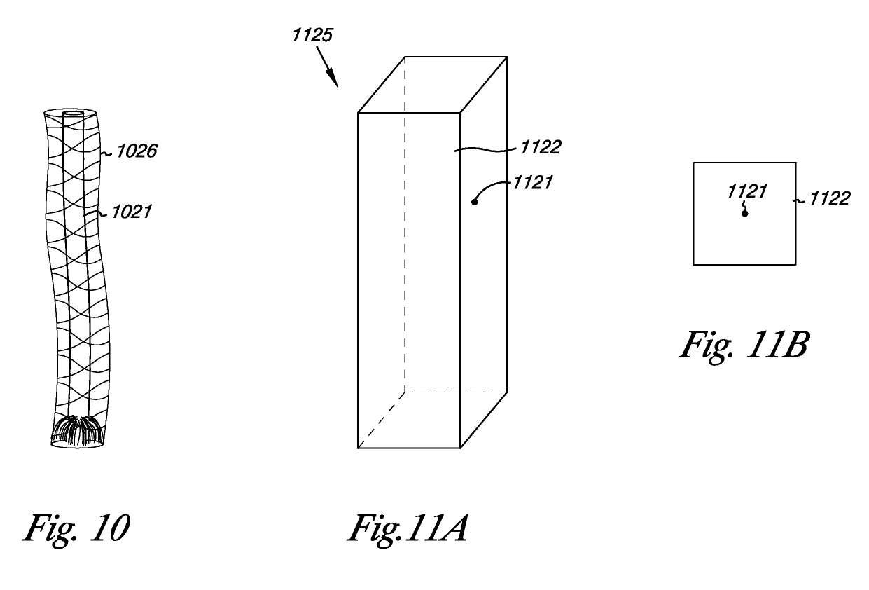

In one or more embodiments, and as illustrated in FIG. 10, at least a portion of the immature plant element (e.g., 821) can be wrapped in a mesh material prior to being frozen. In various embodiments, the mesh material can be a relatively non-stretchable material such as Kevlar, for instance. In various embodiments, the mesh material can provide a reinforcing tension member for an encasement insertion structure. In some embodiments, the mesh material can be configured to allow growth of roots therethrough.

In the embodiment illustrated in FIGS. 8A and 8B, the encasement insertion structure 825 has a generally cylindrical shape (e.g., a cylinder with a circular cross-section as shown in FIG. 8B). However, embodiments are not limited to encasement insertion structures having a particular shape. For instance, the encasement insertion structure 825 can have a cross-sectional shape that is square, triangular, and/or hexagonal, among various other shapes.

The encasement insertion structure 825 can have various thicknesses. In one or more embodiments, the encasing material (e.g., 822) has a thickness of at least one millimeter. The thickness of the encasing material can depend on various factors such as the planting method or device being used to plant the immature plant element. An increased thickness of the encasing material may provide benefits such, as ensuring the mechanical integrity of the structure 825 upon planting, among other benefits.

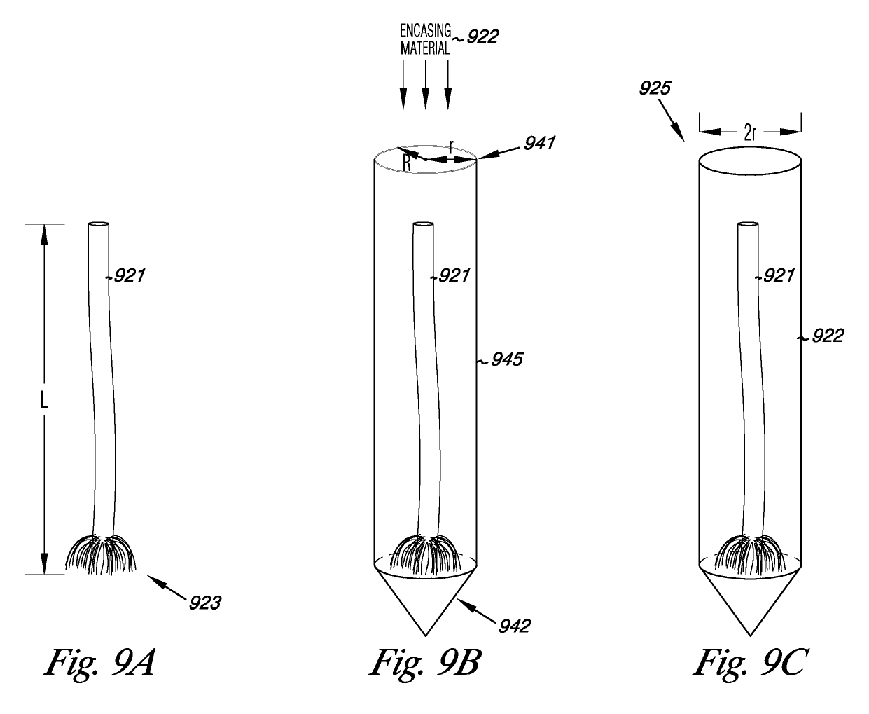

In one or more embodiments and as described further in connection with FIGS. 9A-9C, the immature plant element (e.g., 821) can be a rooted culling and the encasing material (e.g., 822) can be formed around the roots of the rooted cutting.

In one or more embodiments, preparing an immature plant element (e.g., 821) for planting can include inserting at least a portion of the immature plant element into a structure for forming an encasement insertion structure (e.g., 825). An example of a structure for forming an encasement insertion structure is illustrated in FIG. 9B.

In one or more embodiments, the structure can be an elongate hollow tube. In such embodiments, forming the encasement insertion structure (e.g., 825) can include forming the encasing material (e.g., 822) around the immature plant element, (e.g., 821) within the elongate hollow tube. In some embodiments, the encased portion of the immature plant element can be removed from the elongate hollow tube prior to inserting the immature plant element in the ground surface (e.g., 824).

One or more embodiments of the present disclosure can include contacting at least one of an immature plant element (e.g., 821) and an encasing material (e.g., 822) with a ram (e.g., ram 810) to insert the at least a portion of the immature plant element in the ground surface. As an example, the encasement insertion structure 825 can be used in conjunction with one or more of the embodiments described above in connection with FIGS. 1-7. However, encasement insertion structures described herein can be used in conjunction with other planting methods or devices such as with manual planting (e.g., hand planting) or with pneumatic planting devices, among various other planting methods and devices.

FIG. 9A illustrates an immature plant element 921 that can be planted in accordance with one or more embodiments of the present disclosure. In the embodiment illustrated in FIGS. 9A-9C, the immature plant element is a rooted tree cutting 921 that includes a root ball 923 and has a length (L).

FIG. 9B illustrates a structure 945 for forming an encasement insertion structure (e.g., encasement insertion structure 825 shown in FIG. 8A or encasement insertion structure 925 shown in FIG. 9C) for planting in accordance with one or more embodiments of tire present disclosure. In the embodiment illustrated in FIG. 9B, the structure 945 includes a hollow upper portion 941 having a generally cylindrical shape and a hollow lower portion 942 having a generally conical shape.

In the embodiment illustrated in FIG. 9B, the hollow upper portion 941 of structure 945 has an inner radius (r) and an outer radius (R). The structure 945 can be made of various materials. For instance, the structure 945 can be made of a plastic material. In one or more embodiments, the structure 945 can be made of a degradable material such as cardboard or pasta, among various other degradable materials. In some embodiments, at least a portion of the structure 945 can be planted along with the immature plant element (e.g., 921). In such embodiments, providing a structure 945 made of a degradable material can maintain a mechanical integrity of the immature plant element during planting and can also subsequently degrade to facilitate growth of the immature plant element.

In one or more embodiments, the immature plant element 921 can be prepared for planting by placing the immature plant element 921 into the structure 945 as shown in FIG. 9B. An encasing material 922 can be added to the structure 945 such that it is formed around the plant element 921 in at least two dimensions (e.g., around a portion of the circumference or around at least one end or along a portion of the length of the element). As described above in connection with FIGS. 8A and 8B, the encasing material 922 can include various different materials (e.g., water, soil, fertilizer, saw dust, etc.) or a combination thereof.

In some embodiments, the encasing material 922 can be tightly packed into the structure 945, or a portion thereof, to form a rigid structure around the plant element 921, and/or the contents of the structure 945 (e.g., the encasing material 922 and the immature plant element 921) can be frozen to form a portion of an encasement insertion structure (e.g., 925). In some embodiments, the encasement insertion structure (e.g., 925) is formed by the frozen material upon removal from the structure 945.

FIG. 9C illustrates the encasement insertion structure 925 after removal from the structure 945 shown in FIG. 9B. The encasement insertion structure 925 of the embodiment of FIG. 9C has a diameter, for example, of 2r (twice that of the inner radius of the structure 945 shown in FIG. 9B).

Although in the embodiment illustrated in FIG. 9C the encasing material 922 is formed along the entire length (L) of the immature plant element 921, in one or more embodiments, the encasing material 922 may be formed, for example, only on the rooted portion 923 of the immature plant element 923. In some instances, the upper portion of the plant element 921 (e.g., the non-root portion) may be mechanically stable enough to withstand contact from a planting device (e.g., a ram) despite not having an encasing material formed thereon.

FIG. 10 illustrates an immature plant element 1021 for planting in accordance with one or more embodiments of the present disclosure. In the embodiment illustrated in FIG. 10, the immature plant element 1021, or a portion thereof is wrapped in a mesh material 1026. In one or more embodiments, an encasing material can be formed around at least a portion of the wrapped plant element.

For instance, the wrapped plant element shown in FIG. 10 can be placed in a structure such as structure 945 shown in FIG. 9B. In some embodiments, after the encasing material is formed around the wrapped plant element, the resulting encasement insertion structure (e.g., 925 shown in FIG. 9C) can be removed from the structure 945. Wrapping the plant element (e.g., 1021) in a mesh material can, for example, increase the mechanical stability of the resulting encasement insertion structure, among other benefits.

The mesh material 1026 can be various natural and/or synthetic materials such as hemp, cotton, nylon, Kevlar, and/or various metals, among other materials. The mesh material 1026 can be configured such that the spacing associated with the mesh material is suitable for allowing growth of the immature plant element 1021. In one or more embodiments, the spacing of the mesh material 1026 is about 1 cm square. However, embodiments are not limited to a particular spacing.

FIG. 11A illustrates an encasement insertion structure 1125 for planting in accordance with one or more embodiments of the present disclosure. FIG. 11B is a cross-sectional view of the embodiment illustrated in FIG. 11A. In the embodiment illustrated in FIGS. 11A and 11B, the encasement insertion structure includes an immature plant element 1121 encapsulated in an encasing material 1122.

In the embodiment illustrated in FIGS. 11A and 11B, the immature plant element is a seed 1121. The location of the seed 1121 within the structure 1125 can be varied and can depend on factors such as the desired planting depth for the particular type of seed. As an example, assume the encasement insertion structure 1125 has a length often inches and that a planting device (e.g., a planting device such as that described in FIGS. 1-7 above) is configured to insert seven inches of the structure into the ground. Also assume the appropriate planting depth for the seed 1121 is about three inches. In this example, the encasement insertion structure 1125 can be formed such that the seed 1121 is located about four inches from the lower end (i.e., about six inches from the upper end) such that, upon placing, the seed 1121 is located at the appropriate planting depth of about three inches below the ground surface.

in the embodiment illustrated in FIGS. 11A and 11B, the encasement insertion structure 1125 has a square cross section. However, as noted above, embodiments of the present disclosure are not limited to encasement insertion structures having a particular cross-sectional shape.

Various methods, structures, and devices for planting of immature plant elements such as tree slips, seedlings, and other immature plant elements in a ground surface have been described herein. One or more embodiments include an encasement insertion structure for planting that includes an immature plant element having a length and a circumference and an encasing material formed to surround at least a portion of the immature plant element around the circumference for facilitating insertion of the immature plant element through a ground surface.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim.

Rather, as the following claims reflect, inventive subject matter lies in less than all features of a single disclosed, embodiment. Thus, the following claims are hereby incorporated into the Detailed Description, with each claim standing on its own as a separate embodiment.

What is claimed is:

1. An encasement insertion structure for planting, comprising:
an immature plant element having a length and a circumference; and
an encasing material formed to surround at least a portion of the immature plant element around the circumference for facilitating insertion of the immature plant element through a ground surface.

2. The structure of claim 1, wherein the encasing material is sufficiently rigid to maintain a structural integrity of the immature plant element upon penetration through the ground surface.

3. The structure of claim 1, wherein the encasing material has a generally cylindrical shape.

4. The structure of claim 1, wherein the encasing material has a thickness of at least one millimeter.

5. The structure of claim 1, wherein the immature plant element includes at least one element selected from the group including:
a tree slip;
a seedling;
a rooted cutting; and
a seed.

6. The structure of claim 3, wherein the encasing material formed on the immature plant element includes ice.

7. The structure of claim 1, wherein the encasing material formed on the immature plant element includes an organic material.

8. The structure of claim 1, wherein the immature plant element is a rooted cutting and the encasing material is formed around the roots of the rooted cutting.

9. A method for preparing an immature plant element for planting, comprising:
encapsulating at least a portion of the immature plant element in an encasing material having sufficient rigidity to maintain a structural integrity of the immature plant element during penetration of a ground surface.

10. The method of claim 9, wherein the method includes freezing at least a portion, of the encasing.

11. The method of claim 9, wherein the encasing material includes sawdust.

12. The method of claim 9, wherein the encasing material includes plant nutrients therein.

13. The method of claim 9, wherein the method includes encasing the at least a portion of the immature plant element by placing the portion into a solidified encasement structure having a space provided within the structure for placement of the portion of the immature plant element.

14. The method of claim 9, wherein the method includes inserting the at least a portion of the immature plant element into an elongate hollow tube and forming the encasing around the immature plant element within the elongate hollow tube.

15. The method of claim 14, wherein the method includes removing the encased at least a portion of the immature plant element from the elongate hollow tube prior to inserting the immature plant element in the ground surface.

16. A method, for planting an immature plant element, comprising:
inserting at least a portion of the immature plant element in a ground surface, wherein the immature plant element includes:
an encasing material formed thereon for facilitating penetration of the immature plant element through the ground surface.

17. The method of claim 16, wherein the method includes contacting at least one of the immature plant element and the encasing material with a ram to insert the at least a portion of the immature plant element in the ground surface.

18. The method of claim 16, wherein the encasing material is a rigid material.

19. The method of claim 16, wherein the immature plant element is a conifer seedling.

20. The method of claim 16, wherein the encasing material is a frozen material.

21. The method of claim 20, wherein the frozen material includes one or more degradable materials therein.

22. The method of claim 20, wherein the method includes wrapping the at least a portion of the immature plant element in a mesh material prior to freezing the encasing material.
